(19) United States
(12) Patent Application Publication
(10) Pub. No.: US 2013/0083020 A1
(43) Pub. Date: Apr. 4, 2013

(54) THREE-DIMENSIONAL DATA PROCESSING APPARATUS, THREE-DIMENSIONAL DATA PROCESSING METHOD, AND THREE-DIMENSIONAL DATA PROCESSING PROGRAM

(71) Applicants: Junichi SHIMAMURA, Yokohama-shi (JP); Masahiro MOTOHASHI, Yokohama-shi (JP); Makoto HATAKEYAMA, Yokosuka-shi (JP); Shizuka KIMURA, Yokohama-shi (JP)

(72) Inventors: Junichi SHIMAMURA, Yokohama-shi (JP); Masahiro MOTOHASHI, Yokohama-shi (JP); Makoto HATAKEYAMA, Yokosuka-shi (JP); Shizuka KIMURA, Yokohama-shi (JP)

(73) Assignee: Kabushiki Kaisha Toshiba, Tokyo (JP)

(21) Appl. No.: 13/611,409

(22) Filed: Sep. 12, 2012

(30) Foreign Application Priority Data
Oct. 4, 2011 (JP) 2011-220263

(51) Int. Cl. G06T 17/00

(52) U.S. Cl. 345/420

(57) ABSTRACT

A three-dimensional data processing apparatus includes: a superposition unit configured to superpose obtained point group data and CAD data on a three-dimensional coordinates; a segment extraction unit configured to extract a segment of the point group data corresponding to each of a CAD parts which is constituent of the CAD data; and a segment operating unit configured to operate the segment in the three-dimensional coordinates.

### CROSS-REFERENCE TO RELATED APPLICATIONS

This application is based upon and claims the benefit of priority from Japanese Patient application No. 2011-220263, filed on Oct. 4, 2011, the entire contents of each of which are incorporated herein by reference.

### FIELD

Embodiments of the present invention relate to a three-dimensional data processing technology which processes a three-dimensional image obtained by a laser scanning of structure.

### BACKGROUND

It is known such a technology that actual measurement of the structure with a laser scan to recognize the surface shape of the structure with the point group data which is an aggregation of three-dimensional position data. In this technology, the laser scanner is arranged at two or more different reference points to obtain the point group data respectively, and then each point group data are superposed to carry out three-dimensional computerization of the large-scale and complicated forms, such as a plant, a work site, rows of houses, and cultural-assets structure.

By the way, structure such as a plant of various industries and the like, repair work, reconstruction, and extension construction are performed frequently. In these constructions, structure causes operation of conveying articles such as apparatus and material, inside and exterior of the structure.

Then consideration of the conveyance method of these articles is carried out by a simulation on a computer using three-dimensional CAD data which is the compilation of design information (for example JP2010-211736A).

However, a difference in shape may exist between a real structure and the three-dimensional CAD data because shape may change through the repair work etc. even if the same at the beginning. For this reason, the conveyance simulation of the article may not be carried out correctly only based on the three-dimensional CAD data at the time of a design. Then it is disclosed a technology for raising accuracy of the conveyance simulation of an article by superposing the three-dimensional CAD data and the point group data obtained from the actual measurement of the structure with a laser scan etc. (for example JP2005-181131A).

However, it was difficult to consider a conveyance simulation with taking into account each attributes (a size, shape, etc.) of components (piping, apparatus, etc.), since the point group data obtained from actual measurement of the structure is a continuous substantial data.

Besides it was difficult to follow an image display with momentarily changing structure made of the point group data according to progression of the article conveyance.

The present embodiment was made in consideration of such a situation, and aim at providing a three-dimensional data processing technology for dividing the point group data obtained from an actual measurement of the structure into each component to operate them on a three-dimensional coordinates.

### BRIEF DESCRIPTION OF THE DRAWINGS

FIG. 1 is a block diagram showing an embodiment of a three-dimensional data processing apparatus according to the present invention.

FIG. 2 is a display image showing a point group data.

FIG. 3 is a display image showing a CAD data constituted by various CAD parts.

FIG. 4 is a superposition image showing a point group data and a CAD data.

FIG. 5 is a display image showing a point group data divided into several segments corresponding to each CAD parts.

FIG. 6 is a display image showing a partial point group data to be changed into a CAD parts.

FIG. 7 is a display image showing a simulation for conveying one of the components outside.

### DETAILED DESCRIPTION

Hereafter, the embodiment of the present invention is described based on an accompanying drawing.

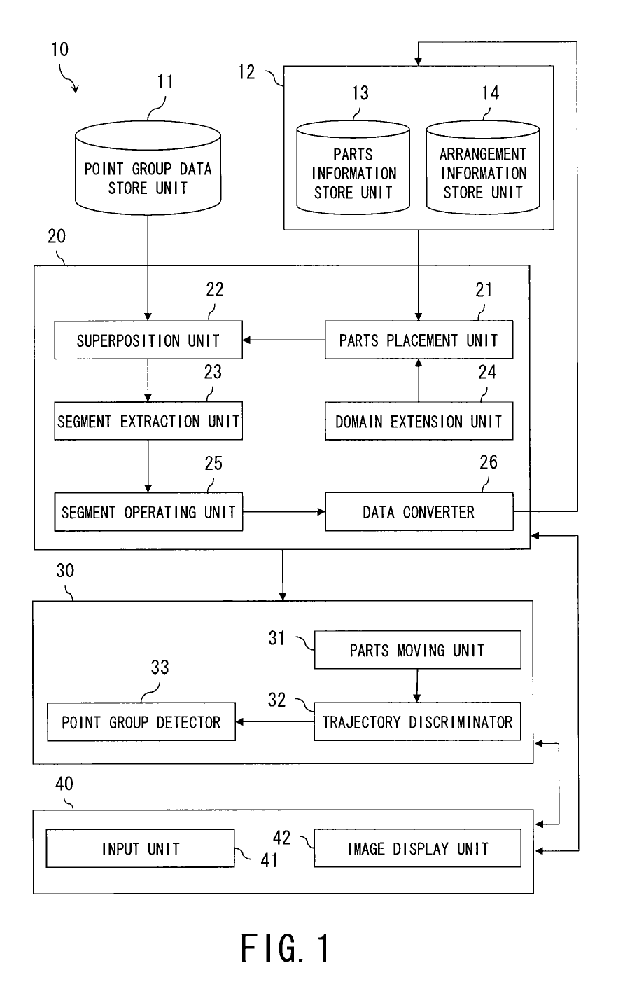

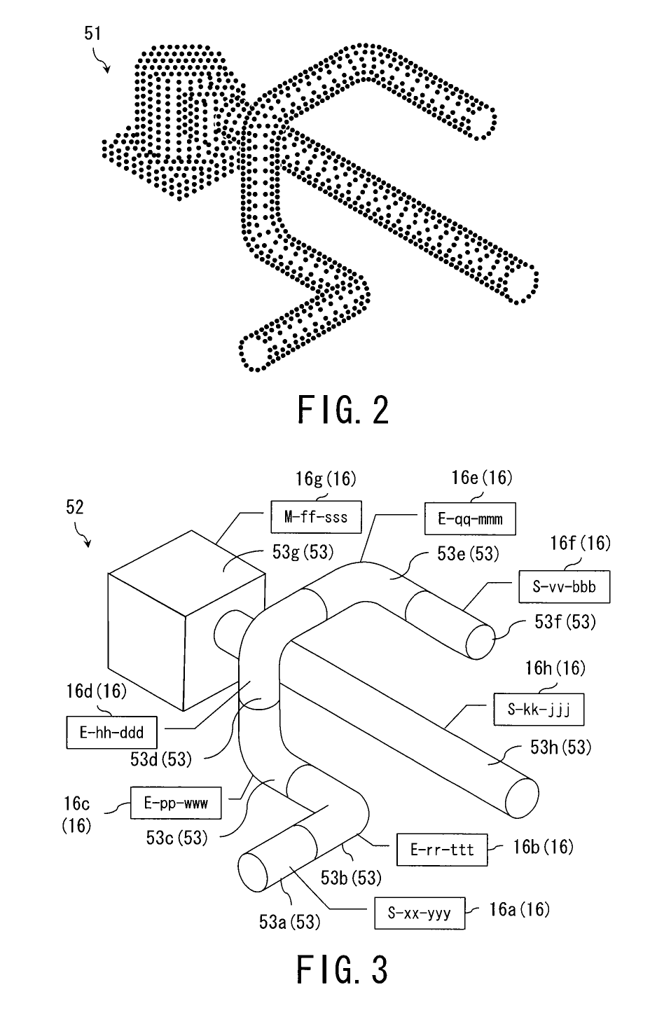

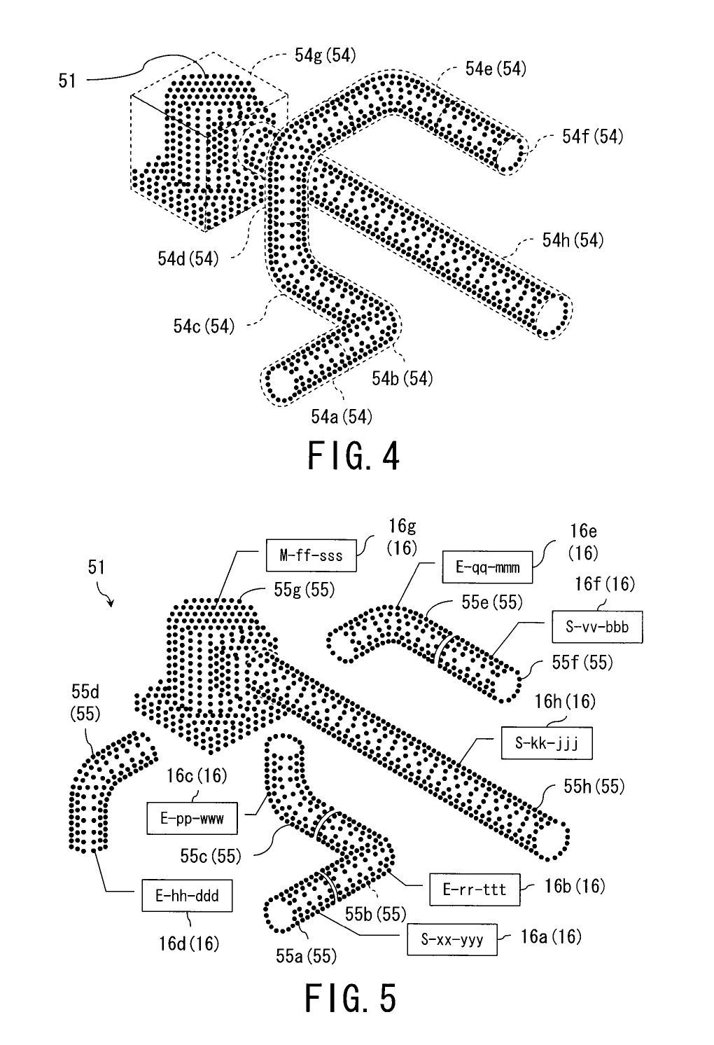

As shown in FIG. 1, the three-dimensional data processing apparatus 10 includes: the superposition unit 22 configured to superpose obtained point group data 51 (FIG. 2) and the CAD data 52 (FIG. 3) on the three-dimensional coordinates (refer to FIG. 4), the segment extraction unit 23 configured to extract the segment 55 (55a-55h) (FIG. 5) of the point group data 51 corresponding to each of the CAD parts 53 (53a-53h) (FIG. 3) which is constituent of the CAD data 52, and the segment operating unit 25 configured to operate the segment 55 (55a-55h) in the three-dimensional coordinates.

The point group data 51 (FIG. 2) stored in a unit 11 is a data file of the three-dimensional image of the structure. The three-dimensional image is measured by detecting a reflected light of the laser scanned the surface of the structure. The point group data 51 in one measurement is superposed each of the three-dimensional image obtained two or more laser scanner arranged at different reference points. The three-dimensional image obtained from single reference point comprises several ten million numbers of pixels.

Although the dot shown in FIGS. 2, 4, 5, 6, and 7 imitates the pixel of a three-dimensional image, an actual pixel is not necessarily recognized visually in the shape of a dot illustrated like that.

A CAD data store unit 12 includes: the parts information store unit 13 configured to store various CAD parts 53 (FIG. 3) and the attribute information 16 thereof, and the arrangement information store unit 14 configured to store the arrangement information of CAD parts 53 in the three-dimensional coordinates.

The components of the structure are registered as the CAD parts 53 such as multi-use parts for example piping and the like which is standardized shape, tube diameter, length, material and so on. On the other hand, the component with complicated shape may be transposed to an abstract image (for example, reference character 53g). Here, the attribute information 16 means varieties of information (parts number etc.) incidental to each of the CAD parts 53.

The data processing unit 20 acquires the point group data 51 and the CAD data 52 from the store units 11 and 12 according to the information from the input unit 41 of the human interface unit 40. Then the unit 20 makes to display the three-dimensional image of the structure on the image display unit 42 after performs various processing.

The parts placement unit 21 arranges the CAD parts 53 acquired from the store unit 13 based on the arrangement data acquired from the store unit 14, and then forms the CAD data 52 of a structure in the three-dimensional coordinates (refer to FIG. 3).

The superposition unit 22 superposes the point group data 51 (FIG. 2) consists of the aggregation of many pixels, and the CAD data 52 (FIG. 3) arranged two or more CAD parts 53 in the three-dimensional coordinates.

In the image display unit 42, the superposition image of the point group data 51 (FIG. 2) and the CAD data 52 (FIG. 3) is displayed. Generally, it may not be in agreement between the CAD data 52 created before construction of a structure and the point group data 51 reflected the structure a certain time passed after construction, because implementation of repair, reconstruction, etc. are done to the structure.

Some concrete methods are mentioned about the segment extraction unit 23 extracts segment 55 (55a-55h) (FIG. 5) of the point group data 51 corresponding to the CAD parts 53 (53a-53h) (FIG. 3).

The domain extension unit 24 configured to set the extended domain 54 (dashed line in FIG. 4) formed by extending the occupied domain (real line in FIG. 3) of the CAD parts 53. Thereby the segment 55 (55a-55h) of the point group data 51 is extracted based on the extended domain 54 (54a-54h).

As other methods, the segment 55 (55a-55h) can also be extracted as the portion of the point group data 51 which takes the shortest distance from the surface coordinates of the CAD parts 53.

As shown in FIG. 5, the segment operating unit 25 can display the segments [55g and 55h] image hidden back the specified segment 55d by moving operation in the three-dimensional coordinates. In addition, the segment operating unit 25 can perform various operations such as deletion, expansion, reduction, rotation, color change, etc. to the specified segment 55.

Hereby, the conveyance simulation of the component in the structure, actual work can be faithfully reproduced by operating the specified segment 55 in the point group data 51.

As shown in FIG. 3, the image display unit 42 can display the attribute information 16 (16a-16h) of the CAD parts 53, and as shown in FIG. 5, the attribute information 16 (16a-16h) is assigned also on the extracted segment 55 (55a-55h).

Thus, also about the segment 55 of the point group data 51, the attribute information 16 can be referred to and the visibility of stocktaking of the structure improved.

The data converter 26 configured to convert the segment 55 of the point group data 51 into the CAD parts 53.

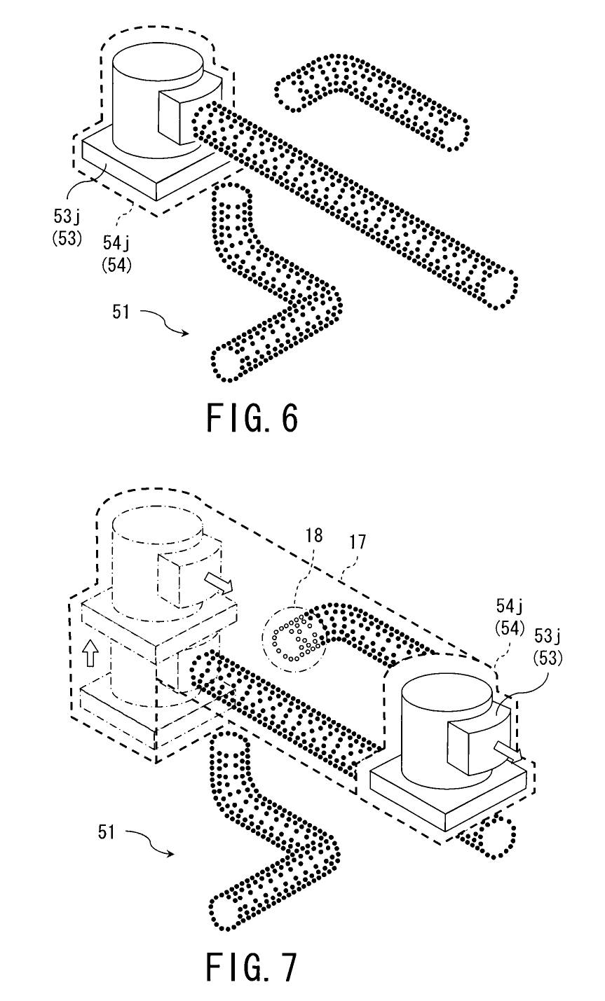

Thereby, the complicated shape component expressed in the CAD parts 53g (FIG. 3) of the abstract image is expressed as the CAD parts 53j faithful to actual shape, as shown in FIG. 6.

The attribute information 16 incidental to the segment 55 can be taken over to the converted CAD parts 53 as it is.

As shown in FIG. 1, the move analyzing units 30 contains; the parts moving unit 31 configured to move the CAD parts 53 or the segments 55 or the extended domains 54 thereof in the three-dimensional coordinates, the trajectory discriminator 32 configured to discriminate the trajectory field 17 formed with moving parts in the three-dimensional coordinates, and the point group detector 33 configured to detect the overlap areas 18 of the trajectory field 17 and the point group data 51.

Referring to FIG. 6 and FIG. 7, it is illustrated under the various constructions of a plant, the conveyance simulation with the key object for interference verification of the fixed components in the structure and the conveyance component.

In the various constructions in the nuclear plant etc., it is demanded for high accuracy the conveyance simulation of component such as piping or apparatus precisely arranged in the structure.

As shown in FIG. 6, the domain extension unit 24 sets up the extended domain 54j which has larger offset to the moving target of the CAD parts 53j. The offset is set up with estimating the installing space of the supporting member for the parts 53j to move, and the margin thereof to avoid contacting with other parts 53.

In accordance with the conveying path set up by the parts moving unit 31, the parts 53j and the extended domain 54j move in the three-dimensional coordinates.

The trajectory discriminator 32 generates the trajectory field 17 which enveloped the trajectory of the parts 53j and/or the extended domain 54j thereof which moves in accordance with the conveying path.

By verifying overlapping among the trajectory field 17 of parts and the point group data 51 of the structure to specify the interference object at the time of the conveyance, that the conveyance plan of parts can be produced with more efficient and excellent in safety.

The point group detector 33 judges the overlap areas 18 contained inside the trajectory field 17 among the point group data 51. The field the extended domain 54j overlaps among the overlap areas 18 is a portion with a high risk of interfering at the time of conveyance of the parts 53j, and the portion the parts 53j overlapped is judged to be a portion which interferes certainly as the hindrance of conveyance.

The image display unit 42 indicates the interference portion or the risky portion among the overlap areas 18 by classification with color and then displays the attribute information 16 of them. Thereby, the listing of the interference object becomes easy.

At least one embodiment of the three-dimensional data processing apparatus described above, since the three-dimensional image of the structure expressed by the point group data based on actual measurement can be operated by components as a unit, the conveyance simulation of the components with high-precision is realized.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

The three-dimensional data processing apparatus is possible also for realizing each unit by computer, and can also be implemented by installing the three-dimensional data-processing program.

What is claimed is:

1. A three-dimensional data processing apparatus, comprising:
a superposition unit configured to superpose obtained point group data and a CAD data on a three-dimensional coordinates;
a segment extraction unit configured to extract a segment of the point group data corresponding to each of a CAD parts which is constituent of the CAD data; and
a segment operating unit configured to operate the segment in the three-dimensional coordinates.

2. The three-dimensional data processing apparatus according to claim 1, further comprising:
a domain extension unit configured to set a extended domain formed by extending an occupied domain of the CAD parts; wherein
the segment of the point group data is extracted based on the extended domain.

3. The three-dimensional data processing apparatus according to claim 1, wherein
an attribute information of the CAD parts is assigned on the corresponded segment.

4. The three-dimensional data processing apparatus according to claim 1, further comprising:
a data converter configured to convert the segment of the point group data into the CAD parts.

5. The three-dimensional data processing apparatus according to claim 1, further comprising:
a trajectory discriminator configured to discriminate a trajectory field formed with moving the CAD parts, the segment, or an extended domain thereof in the three-dimensional coordinates.

6. The three-dimensional data processing apparatus according to claim 5, further comprising:
a point group detector configured to detect an overlap area of the trajectory field and the point group data.

7. A three-dimensional data processing method, comprising the steps of:
superposing obtained point group data and CAD data on a three-dimensional coordinates;
extracting a segment of the point group data corresponding to each of a CAD parts which is constituent of the CAD data; and
operating the segment in the three-dimensional coordinates.

8. A three-dimensional data processing program to be executed by a computer that performs functions of:
superposing obtained point group data and CAD data on a three-dimensional coordinates;
extracting a segment of the point group data corresponding to each of a CAD parts which is constituent of the CAD data; and
operating the segment in the three-dimensional coordinates.
